(19) United States
(12) Patent Application Publication
(10) Pub. No.: US 2023/0053892 A1
(43) Pub. Date: Feb. 23, 2023

(54) METHOD AND APPARATUS FOR PROVIDING SUBSCRIPTION NOTIFICATION SERVICE

(71) Applicant: KAKAO CORP., Jeju-si (KR)

(72) Inventors: Yi Kyong LIM, Seongnam-si (KR); Ji Sun PARK, Seongnam-si (KR); Min Kyoung CHO, Seongnam-si (KR); Hye Jin JUNG, Seongnam-si (KR); In Jin HUR, Seongnam-si (KR); Seung Hee HAN, Seongnam-si (KR); Seon Ju PARK, Seongnam-si (KR); Eun Young CHOI, Seongnam-si (KR); Hye Min NAM, Seongnam-si (KR); Han Soo CHOI, Seongnam-si (KR); In Haeng JO, Seongnam-si (KR); Hoe Lyeon KIM, Seongnam-si (KR); Kwang Seok SEO, Seongnam-si (KR); Yong Hun LEE, Seongnam-si (KR); Gyung Ha KIM, Seongnam-si (KR)

(21) Appl. No.: 17/891,131

(22) Filed: Aug. 19, 2022

(30) Foreign Application Priority Data
Aug. 20, 2021 (KR) 10-2021-0110509

(51) Int. Cl. G06Q 30/06; G06Q 30/02

(52) U.S. Cl. CPC G06Q 30/0633; G06Q 30/0283; G06Q 30/0222

(57) ABSTRACT

Provided is a method and apparatus for providing a subscription notification service. A method of providing a subscription notification service includes extracting data on a subscription notification of which a date is approaching, requesting a transmission of a notification message corresponding to the subscription notification data, generating a to-buy list including order information of at least one first product, and providing the generated to-buy list to a terminal of a user transmitting a purchase request.

### CROSS-REFERENCE TO RELATED APPLICATION

This application claims the benefit of Korean Patent Application No. 10-2021-0110509 filed on Aug. 20, 2021, in the Korean Intellectual Property Office, the entire disclosure of which is incorporated herein by reference for all purposes.

### BACKGROUND

### 1. Field of the Invention

One or more example embodiments relate to a method and apparatus for providing a subscription notification service.

### 2. Description of the Related Art

The number of users using an online store platform through an electronic device is on the rise due to the development of wired and wireless communications and the popularization of smart phones. The online store platform is an e-commerce platform that enables consumers to purchase goods or services from sellers in an online communication network. As various online store platforms are introduced, online store platforms provide sales or purchase services of products/services in various forms. Services related to a subscription are actively traded online so that goods and/or services may be purchased or subscribed on a regular basis. Accordingly, there is a need to develop technology for facilitating a subscription notification service to continue a transaction and improve the convenience of repetitive purchases.

### SUMMARY

According to an aspect, there is provided a method of providing a subscription notification service performed by a server interworking with a messaging server, the method including extracting data on a subscription notification, of which a date is approaching, based on a database storing information about the subscription notification set in response to a concluded order book; requesting the messaging server to transmit a notification message corresponding to the subscription notification data based on seller's identification information and buyer's identification information included in the extracted subscription notification data; generating a to-buy list including order information of at least one first product corresponding to the subscription notification data in response to a purchase request through the notification message; and providing the generated to-buy list to a terminal of a user transmitting the purchase request.

The to-buy list may be a digital shopping cart dedicated to the subscription notification service which is newly generated in response to a purchase request of an applicable notification cycle in each notification cycle that comes periodically from the subscription notification service and automatically deleted when the applicable notification cycle ends

The method of providing the subscription notification service may include, in response to each of products included in the to-buy list, determining whether an applicable product corresponds to a product in the subscription notification data; identifying a price to which a discount by the subscription notification service is applied when the applicable product corresponds to the product in the subscription notification data; and identifying a price to which a discount by the subscription notification service is not applied when the applicable product does not correspond to the product in the subscription notification data,

A total price determined based on the identified prices of the applicable products may be provided through the to-buy list.

The to-buy list may be modified to include at least one second product other than the at least one first product in response to a current notification cycle.

The generating of the to-buy list may include retrieving data on at least one subscription-notification target corresponding to the subscription notification data in the database in response to the purchase request though the notification message; and generating the to-buy list including order information of the first product based on the retrieved subscription-notification target data.

The extracting of the subscription notification data may further include updating a subscription notification date corresponding to the subscription notification data stored in the database, based on a time interval of the subscription notification included in the subscription notification data.

The information about the subscription notification may include the subscription notification data generated in response to the order book for which the subscription notification is set; and subscription-notification target data generated based on order information of at least one product included in the order book.

The notification message may be transmitted to a terminal logged into an account of a second user corresponding to the buyer's identification information through a channel of a first user corresponding to the seller's identification information.

The providing of the to-buy list may further include receiving an order request corresponding to the to-buy list from the terminal of the user.

According to another aspect, there is provided a server interworking with a messaging server to provide a subscription notification service, the server including at least one processor. The processor may be configured to extract data on a subscription notification of which a date is approaching based on a database storing information about the subscription notification set in response to a concluded order book, requesting the messaging server to transmit a notification message corresponding to the subscription notification data based on seller's identification information and buyer's identification information included in the extracted subscription notification data, generating a to-buy list including order information of at least one first product corresponding to the subscription notification data in response to a purchase request through the notification message, and providing the generated to-buy list to a terminal of a user transmitting the purchase request.

The to-buy list may be a digital shopping cart dedicated to the subscription notification service which is newly generated in response to a purchase request of an applicable notification cycle in each notification cycle that comes periodically from the subscription notification service and automatically deleted when the applicable notification cycle ends. The processor may be configured to, in response to each of products included in the to-buy list, determine whether an applicable product corresponds to a product in the subscription notification data, identify a price to which a discount by the subscription notification service is applied when the applicable product corresponds to the product in the subscription notification data, and identify a price to which a discount by the subscription notification service is not applied when the applicable product does not correspond to the product in the subscription notification data.

A total price determined based on the identified prices of the applicable products may be provided through the to-buy list.

The to-buy list may be modified to include at least one second product other than the at least one first product in response to a current notification cycle.

The processor may be configured to, in the generating of the to-buy list, retrieve data on at least one subscription-notification target corresponding to the subscription notification data in the database in response to the purchase request though the notification message and generate the to-buy list including order information of the first product based on the retrieved subscription-notification target data.

The processor may be configured to, in the extracting of the subscription notification data, update a subscription notification date corresponding to the subscription notification data stored in the database, based on a time interval of the subscription notification included in the subscription notification data.

The information about the subscription notification may include the subscription notification data generated in response to the order book for which the subscription notification is set; and subscription-notification target data generated based on order information of at least one product included in the order book.

The notification message may be transmitted to a terminal logged into an account of a second user corresponding to the buyer's identification information through a channel of a first user corresponding to the seller's identification information

The processor may, in providing the to-buy list, receive an order request corresponding to the to-buy list from the terminal of the user.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is an operation flowchart of a method of providing a subscription notification service according to an example embodiment;

FIG. 2 is a diagram illustrating an example of subscription notification data and subscription-notification target data stored in a database according to an example embodiment;

FIG. 3A is a diagram illustrating a configuration of a subscription notification message according to an example embodiment;

FIG. 3B is a diagram illustrating an interface related to a to-buy list according to an example embodiment;

FIG. 3C is a diagram illustrating an interface related to an order book according to an example embodiment;

FIGS. 4A and 4B are diagrams illustrating an operation of adding product order information to a to-buy list according to an example embodiment;

FIGS. 5A and 5B are diagrams illustrating an operation of requesting a setting of a subscription notification according to an example embodiment;

FIG. 6A is a diagram illustrating an interface screen for a subscription notification application according to an example embodiment;

FIG. 6B is a diagram illustrating a configuration of a message of completed application for a subscription notification to be sent when a subscription notification for an order book is applied for, according to an example embodiment; and

FIG. 7 is a diagram illustrating an interface screen related to detailed information of a subscription notification according to an example embodiment.

### DETAILED DESCRIPTION

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Hereinafter, example embodiments will be described in detail with reference to the accompanying drawings. When describing the example embodiments with reference to the accompanying drawings, like reference numerals refer to like components and a repeated description related thereto will be omitted.

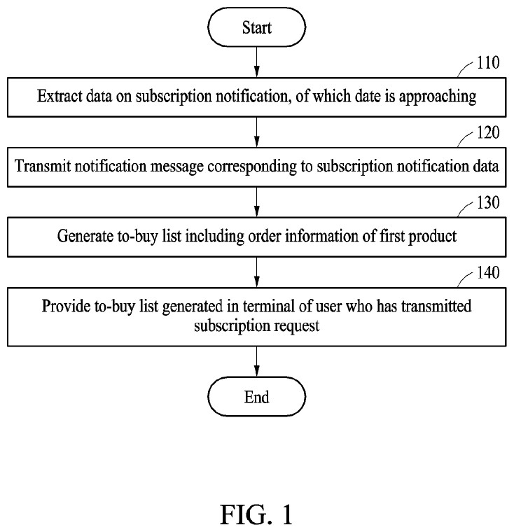

FIG. 1 is an operation flowchart of a method of providing a subscription notification service according to an example embodiment.

Referring to FIG. 1, a method of providing a subscription notification service, according to an example embodiment, may include operation 110 of extracting subscription notification data when a subscription notification date is approaching, operation 120 of requesting a transmission of a notification message corresponding to the subscription notification data, operation 130 of generating a to-buy list including order information of a first product, and operation 140 of providing the generated to-buy list to a terminal of a user who transmits a purchase request.

The to-buy list according to an example embodiment may a digital shopping cart dedicated to the subscription notification service which is newly generated in response to a purchase request of an applicable notification cycle in each notification cycle that comes periodically from the subscription notification service and automatically deleted when the applicable notification cycle ends. The subscription notification service according to an example embodiment may support a regular purchase of a product. For example, the subscription notification service may transmit a message guiding the purchase of a specific product at a predetermined cycle and include a service for providing the to-buy list including order information of an applicable product through a message. The subscription notification service may be provided by a subscription notification server interworking with a messaging server. Hereinafter, the subscription notification server may be simply referred to as “the server”.

According to an example embodiment, the messaging server may include a server which provides a service related to the transmission of a chat message. As an example, the messaging server may include one or more servers, and each server may perform an operation of a service of transmitting a chat message. For example, the messaging server may include an instant messaging server that handles the transmission and reception of general messages between registered accounts and a notification server that processes the transmission and reception of notification messages generated in a predefined form for a notification purpose. As another example, the messaging server may include one or more modules, and each module may be implemented to perform a service of transmitting a chat message.

According to an example embodiment, the server may provide the subscription notification service in response to a product registered in a store platform interlocking with the server. A seller may register and sell a product using the store platform. The seller may determine whether a subscription notification may be set for a product registered in the store platform, and a user who intends to purchase a product available for a subscription notification may request the server that the subscription notification for the product be set. As an example, the seller may set the subscription notification for a product and determine a price to which a discount is applied by the subscription notification service of the product, so that the seller may sell the product at a discounted price to a consumer who sets the subscription notification for the product and purchases the product through a subscription notification message.

According to an example embodiment, the user may use the subscription notification service provided by the server through an account subscribing to the messaging service provided by the messaging server interworking with the server. The instant messaging service may provide various types of accounts, such as a personal account, a corporate account, or a service account. The personal account may be for a general user, the corporate account for a specific company, and the service account for a specific service. The corporate account or the service account may be referred to as a “channel”. For example, a first user may use a channel subscribing to the messaging service interworking with the server to register a product for sale in a store platform interworking with the server. Also, for example, a second user may apply for the subscription notification service for the product registered in the store platform, using a personal account subscribing to the messaging service interworking with the server.

The method of providing the subscription notification service performed by the server interworking with the messaging server according to an example embodiment is described in detail below with reference to FIG. 1.

Referring to FIG. 1, operation 110 according to an example embodiment may include extracting the subscription notification data, in which a subscription notification date is approaching, based on a database storing information about the subscription notification set in response to an order book already concluded.

The database according to an example embodiment may be assessed by the server and include a database that stores information about the subscription notification. The subscription notification may be set in response to the order book, and as the order book is concluded for which the subscription notification is set, information about the subscription notification corresponding to the order book may be generated and stored in the database.

The order book according to an example embodiment may be a unit of concluding an order including order information of at least one product and may, for example, include information about an order for one or more products which is concluded at once in a single payment. The product order information may include information about detailed options (e.g., color and capacity) of a product included in the order book, an order quantity, a price, and/or delivery terms (e.g., a shipping method, type of shipping cost, type of shipping payment, and the like).

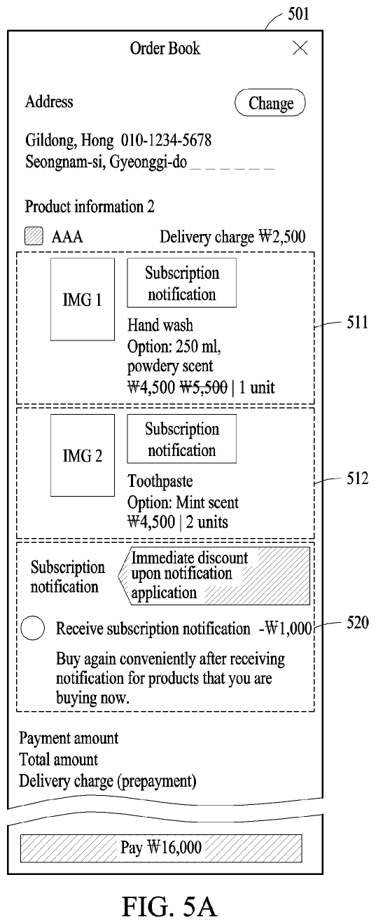

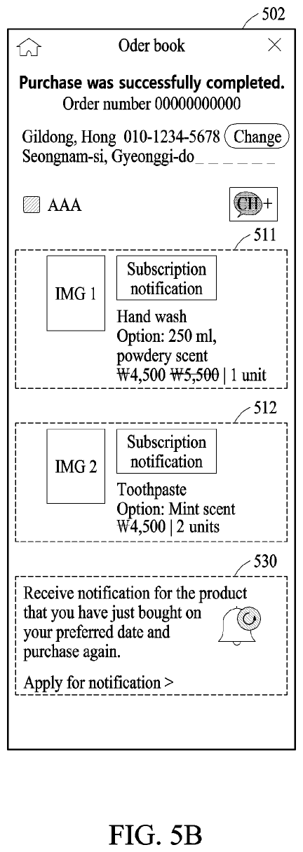

According to an example embodiment, the subscription notification may be set in response to the order book. When the subscription notification may be set for a product included in the order book, order information of the product may be a subscription notification target. That is, the subscription notification set in response to the order book may be applied to the order information of the product when the subscription notification may be set for the product included in the order book. For example, when the subscription notification corresponding to a predetermined cycle is set for the order book, the subscription notification corresponding to the predetermined cycle may be set for order information of one or more products included in the order book and applicable for the subscription notification. A specific method of setting the subscription notification in response to the order book is described in detail below with reference to FIGS. 5A and 5B.

According to an example embodiment, when an order book is concluded for which the subscription notification is set, the server may store, in the database, information about the subscription notification, which is set in response to the concluded order book. For example, information about the subscription notification may include subscription notification data and subscription-notification target data corresponding to the subscription notification.

The subscription notification data according to an example embodiment may be generated in response to the order book for which the subscription notification is set, and unique identification information (e.g., a serial number or an ID) may be assigned to the generated subscription notification data. For example, the subscription notification data generated in response to the order book may include information about assigned identification, identification of a buyer and a seller corresponding to an order book, subscription notification cycle set in response to the order book, and/or a subscription notification period set in response to the order book.

The subscription-notification target data according to an example embodiment may be generated in response to a product included in the order book for which the subscription notification is applied, and the generated subscription-notification target data may include assigned unique identification information (e.g., a serial number or an ID). For example, the subscription-notification target data generated in response to a product included in the order book may include identification information of the subscription notification data corresponding to the subscription-notification target data, identification information of the product, and/or order information of the product. Order information of the product included in the subscription-notification target data may be determined based on the order book. For example, when the order book includes information about ordering two product A's in a first detailed option, the subscription-notification target data corresponding to the product A may include the first detailed option and a quantity of two for the product A in the order information of the product A.

According to an example embodiment, the subscription-notification target data may further include product discount information. As an example, a seller may provide a discount option for a user who sets the subscription notification for the product A to allow the user to buy the product A at a discounted price. The subscription-notification target data corresponding to the product A may include discount information including a discount rate and/or a discounted price compared to a general price of the product corresponding to the discount option.

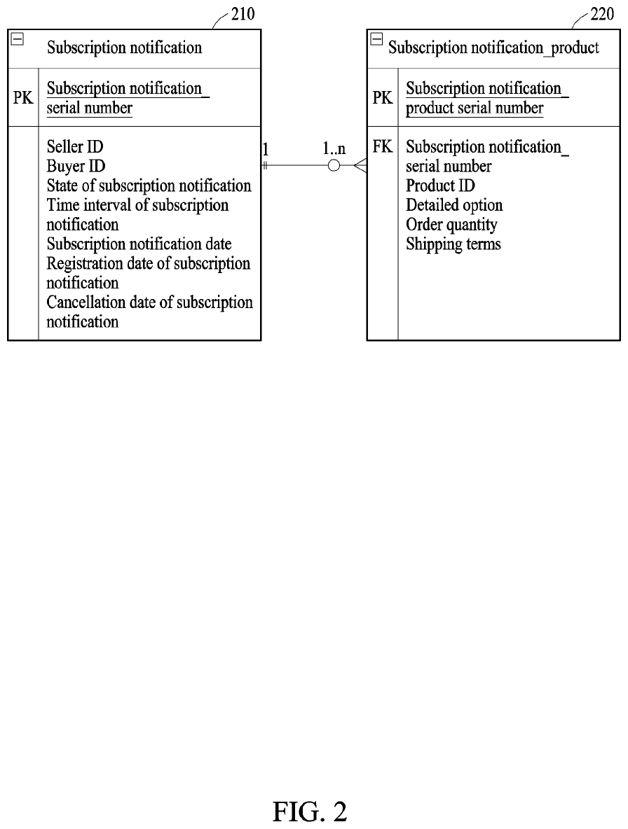

According to an example embodiment, the subscription-notification target data corresponding to the product without the discount option may include a general price of a product B as order information. A specific example of the subscription notification data and the subscription-notification target data stored in the database according to an example embodiment is described in detail with reference to FIG. 2 in the following.

According to an example embodiment, the information about the subscription notification may further include information required for providing the subscription notification service, such as data on subscription notification history and information generated by providing the subscription notification service.

The server according to an example embodiment may extract the subscription notification data, in which a subscription notification date is approaching, from the database. For example, the server may retrieve the subscription notification date of the subscription notification data stored in the database and extract a subscription notification date corresponding to the present point from the subscription notification data.

According to an example embodiment, the subscription notification date may be determined based on a registration date of the subscription notification and a subscription notification cycle. For example, when the subscription notification is registered on January 1 and the subscription notification cycle is one week apart, the subscription notification date may be determined as January 8, a week after January 1. According to the subscription notification cycle, the subscription notification date included in the subscription notification data may be updated. That is, operation 110 of extracting the subscription notification data may further include updating the subscription notification date corresponding to the subscription notification data stored in the database, based on the subscription notification cycle included in the subscription notification data.

Operation 120, according to an example embodiment, may include requesting the messaging server to transmit a notification message corresponding to the subscription notification data, based on identification information of a seller and identification information of a buyer included in the extracted subscription notification data. For example, the notification message corresponding to the subscription notification data may be generated in a predefined form for a notification purpose. The server may request the notification server in the messaging server to transmit the notification message, and the notification server may transmit the notification message in a predetermined form to a terminal logged in with a user's account designated as a recipient through a chatroom of the seller's channel.

According to an example embodiment, the chatroom of the channel may be provided as a different type from a general chatroom, and a message including information about notification or promotion of the seller's service may be transmitted through the chatroom. When a plurality of users requests a conversation in the same channel, a plurality of chatrooms may be generated to allow each user to communicate one on one in the corresponding channel.

According to an example embodiment, the notification message corresponding to the extracted subscription notification data may be transmitted to the buyer's account through the chatroom of the seller's channel corresponding to the subscription notification data. The notification message generated in response to the subscription notification data may include identification information of the subscription notification data. The seller's channel may be identified based on the seller's identification information included in the subscription notification data, and the account of the user who has applied for the subscription notification may be identified based on the buyer's identification information. For example, the notification message may be transmitted through the first user's channel corresponding to the seller's identification information included in the subscription notification data to the second user's account or a terminal logged into the second user's account (hereinafter referred to as the second user's terminal) corresponding to the buyer's identification information. Described hereinafter is a case in which a seller of a product corresponding to the subscription notification data is a channel of the first user and a buyer of the product is the second user.

According to an example embodiment, a notification message may be generated in response to the subscription notification data. For example, the notification message may be generated to include content (e.g., text, images, videos, and/or audio) indicating information about a product corresponding to the subscription notification data and/or content indicating information about the subscription notification included in the subscription notification data.

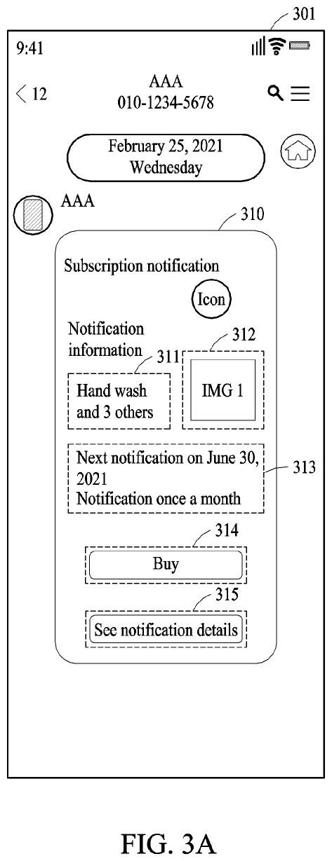

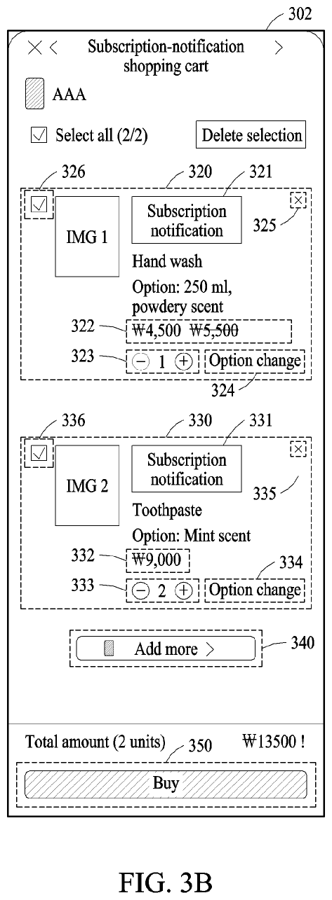

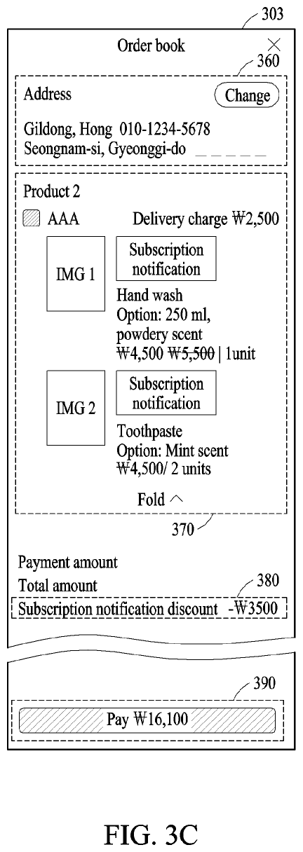

The notification message according to an example embodiment may include an interfacing object for a purchase request. The interfacing object for the purchase request may be implemented to receive a purchase request from a user and transmit a purchase request signal to the server. For example, the interfacing object may include a button implemented to transmit the purchase request signal in response to the user's click input. The detailed configuration of the notification message according to an example embodiment is described in detail in the following with reference to FIG. 3A.

Operation 130 according to an example embodiment may include generating the to-buy list including order information of at least one first product corresponding to the subscription notification data in response to the purchase request through the notification message.

According to an example embodiment, the purchase request through the notification message may include a request to order a product corresponding to the subscription notification data based on identification information of the subscription notification data included in the notification message. For example, the identification information of the subscription notification data included in the notification message may be transmitted to the server in response to the input of selecting an interfacing object for the purchase request included in the notification message. The server may transmit a query corresponding to the identification information of the subscription notification data to the database and retrieve from the database the subscription-notification target data corresponding to the identification information of the subscription notification data. As described in detail hereinafter, the subscription-notification target data stored in the database may include identification information of the subscription notification data, and when the identification information of the subscription notification data is input as a query, the subscription-notification target data including the identification information may be retrieved. The server may generate the to-buy list based on the order information of the product included in the retrieved subscription-notification target data.

The to-buy list according to an example embodiment may include order information of at least one product corresponding to the subscription notification data and may, for example, correspond to a digital shopping cart dedicated to the subscription notification service. The to-do list may be newly generated in response to a purchase request of a corresponding notification cycle in each notification cycle that comes periodically from the subscription notification service and may be automatically deleted as the corresponding notification cycle ends. That is, the to-buy list may correspond to the digital shopping cart that is temporarily generated in response to the notification cycle, unlike a general digital shopping cart.

Operation 130 according to an example embodiment may include retrieving data on at least one subscription target corresponding to the subscription notification data in the database in response to the purchase request though the notification message corresponding to the subscription notification data and generating the to-buy list including order information of a first product based on the retrieved data on the subscription notification target.

The first product may correspond to a product corresponding to the subscription notification data corresponding to the notification message. That is, the first product may correspond to the subscription product data stored in the database in response to the subscription notification data. When the server receives a purchase request through the notification message, the server may generate, as the to-buy list based on the database, order information of the first product included in the order book in which the subscription notification is set. As described in detail hereinafter, in response to a current notification cycle, the to-buy list may be modified by the second user's input to include at least one second product other than the first product. Since the to-buy list is automatically deleted as the notification cycle ends, the to-buy list generated in response to the next notification cycle may include order information of the first product and may not include order information of the second product.

Operation 140 according to an example embodiment may include providing the generated to-buy list to a terminal of the second user who has transmitted a purchase request. The second user's terminal may display the to-buy list received from the server through an interface related to the to-buy list. Hereinafter, the “interface related to the to-buy list” may be referred to as “the interface”. For example, order information of at least one product included in the to-buy list may be visually displayed through the interface. More specifically, when order information of a product A and order information of a product B are included in the to-buy list, the identification information of the product A may be displayed through the interface by using a visual symbol such as a text and/or an image, and order information including at least one of a detailed option, an order quantity, and a selling price corresponding to the product A may be displayed by using the visual symbol.

According to an example embodiment, the interface may provide a function for changing order information of at least one product included in the generated to-buy list. For example, the second user may input a command for changing order information such as an order quantity and/or detailed options of the product included in the to-buy list through the interface. As another example, the second user may input a command for adding order information of a new product to the to-buy list through the interface. The added new product may include a product for which the subscription notification is not set. As another example, the second user may input a command for deleting order information of at least one product included in the to-buy list through the interface. A specific example embodiment of changing the to-buy list through the interface is described in detail hereinafter.

According to an example embodiment, providing the to-buy list in operation 140 may further include receiving an order request corresponding to the to-buy list from the second terminal of the user. The interface according to an example embodiment may include a function for requesting an order corresponding to the to-buy list. For example, the second user may request an order corresponding to the to-buy list through the input of selecting an interfacing object related to the order request included in the interface.

According to an example embodiment, an order for all the products included in the to-buy list may be requested, or an order for some of selected products in the to-buy list may be requested. In response to the order request, the server may generate an order book including information of the product requested to be ordered and provide an interface for payment for the order book to the second user's terminal. A specific example embodiment of requesting the order corresponding to the to-buy list through the interface is described in detail hereinafter.

According to an example embodiment, a method of providing a subscription notification service may include, in response to each of products included in a to-buy list, determining whether an applicable product corresponds to a product in the subscription notification data, and may further include identifying a price to which a discount is applied by the subscription notification service when the applicable product corresponds to the product in the subscription notification data and identifying a price to which a discount is not applied by the subscription notification service when the applicable product does not correspond to the product in the subscription notification data. The total price determined based on the identified prices of the applicable products may be provided through the to-buy list.

As described above, the to-buy list corresponding to a current notification cycle may include order information of at least one first product corresponding to the subscription notification data corresponding to the notification message and order information of at least one second product, which is added by the second user's input. In response to each of the products including the first product and the second product included in the to-buy list, the server may determine whether an applicable product is included in the first product corresponding to the subscription notification data, or in the second product, which is added by the second user's input. When the applicable product is included in the first product, the applicable product may correspond to a product of which order is requested through the subscription notification. When an order of a product is requested through the subscription notification, a discount set by the first user, the seller, may be applicable to the product.

FIG. 2 is a diagram illustrating an example of subscription notification data and subscription-notification target data stored in a database according to an example embodiment.

Referring to FIG. 2, when an order book is concluded for which the subscription notification is set, subscription notification data 210 corresponding to the order book may be generated, and subscription-notification target data 220 corresponding to a product included in the order book may be generated. As described above, the subscription notification data 210 may be generated in units of an order book including order information of one or more products, and one or more sets of the subscription-notification target data 220 corresponding to the subscription notification data 210 may be generated. For example, when the subscription notification is set for the first order book including order information of product A and product B, the first subscription notification data 210 corresponding to the first order book may be generated, and the first subscription-notification target data 220 corresponding to a product A and the second subscription-notification target data 220 corresponding to a product B included in the order book may be generated. The first subscription-notification target data 220 and the second subscription-notification target data 220 may correspond to the first subscription notification data 210. In order to represent a 1:n relationship between the subscription notification data 210 and the subscription-notification target data 220, the subscription-notification target data 220 may include identification information of the subscription notification data 210 as a foreign key.

The subscription notification data 210 according to an example embodiment may be assigned a unique serial number and stored in a database using the assigned serial number as a primary key. For example, the subscription notification data 210 may further include a buyer ID, a seller ID, a subscription notification status, a subscription notification cycle, a subscription notification date, a subscription notification registration date, and a subscription notification cancellation date.

The subscription-notification target data 220 according to an example embodiment may be assigned a unique serial number, and the subscription-notification target data 220 may be stored in a database using the assigned serial number as a basic key. For example, the subscription-notification target data 220 may further include a product ID, detailed options, an order quantity, and delivery conditions.

FIG. 3A is a diagram illustrating a configuration of a subscription notification message according to an example embodiment.

Referring to FIG. 3A, a notification message 310 may be transmitted to a terminal of a second user through a chatroom 301 of a channel of a first user, who is a seller. The notification message 310 may include text 311 and an image 312 indicating information about a product corresponding to subscription notification data, and text 313 indicating information about the subscription notification included in the subscription notification data (e.g., the next notification date and a notification cycle).

The notification message 310 according to an example embodiment may include an interfacing object 314 for a purchase request. In response to an input of selecting the interfacing object 314 for the purchase request included in the notification message 310, identification information of the subscription notification data included in the notification message 310 may be transmitted to a server. The server may query the identification information of the subscription notification data to retrieve subscription-notification target data corresponding to the identification information of the subscription notification data from the database and may generate a to-buy list based on information of the products included in the retrieved subscription-notification target data.

FIG. 3B is a diagram illustrating an interface related to a to-buy list according to an example embodiment. In FIG. 3B, a to-buy list may be displayed and referred to as a “subscription shopping cart”.

Referring to FIG. 3B, the server may provide the generated to-buy list to a terminal of a user who has transmitted a purchase request through a notification message, and the to-buy list may be displayed on a terminal of a second user through an interface 302 related to the to-buy list. For example, when order information of a product A and order information of a product B are included in the to-buy list, an item 320 about the order information of the product A and an item 330 about the order information of the product B may be visually indicated through the interface 302. The item 320 regarding the order information of the product A may include text and images indicating the identification information of product A and may include detailed options corresponding to product A, indicating detailed options, a sale price, and an order quantity. The item 330 regarding the order information of the product B may include text and images indicating the identification information of the product B and may include detailed options corresponding to product B, indicating detailed options, a sale price, and a visual symbol.

As an example, the item 320 regarding the order information of product A and the item 330 regarding the order information of the product B may further include visual indications 321 and 331 to indicate the order information of the products for which the subscription notification is set.

As an example, when a discount option is set for the product A according to a subscription notification application, a discounted price 322 regarding the order information of the product A may be displayed, compared to a general price, in the item 320 about the order information of the product A. When a discount option according to the subscription notification application is not set for the product B, a general price 322 may be displayed in the item 330 about the order information of the product B.

According to an example embodiment, when order information of a product is displayed by default through the interface 302 regarding the to-buy list, the order information of the product may correspond to order information included in the stored subscription notification target corresponding to the subscription notification data in the database. That is, the order information of the product displayed by default through the interface 302 regarding the to-buy list may correspond to order information of a first product corresponding to subscription notification data corresponding to a notification message. The order information of the product included in the to-buy list may be changed by change in a user's input, and the change in the user's input may be received through the interface 302 regarding the to-buy list. For example, each of the items 320 and 330 regarding the order information of the products included in the interface 302 of the to-buy list may further include interfacing objects 323, 324, 333, and 334 for requesting a change in the order information. More specifically, the items 320 and 330 may further include the interfacing objects 323 and 333 for requesting a change in an order quantity and the interfacing objects 324 and 334 for changing information of detailed product options.

According to an example embodiment, order information of a product included in the to-buy list may be deleted by a user's input of deletion, and the user's input of deletion may be received through the interface 302 regarding the to-buy list. For example, each of the items 320 and 330 about the product order information included in the interface 302 regarding the to-buy list may further include interfacing objects 325 and 335 for requesting deletion of the corresponding order information.

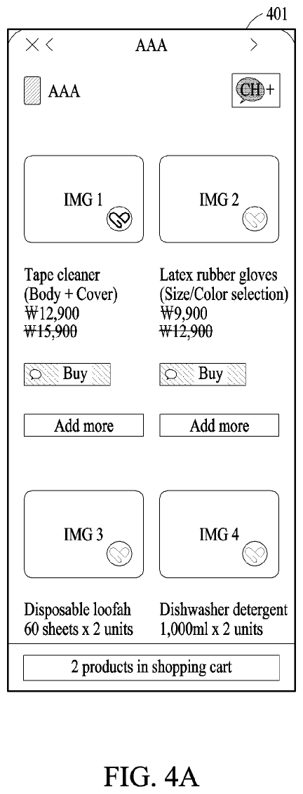

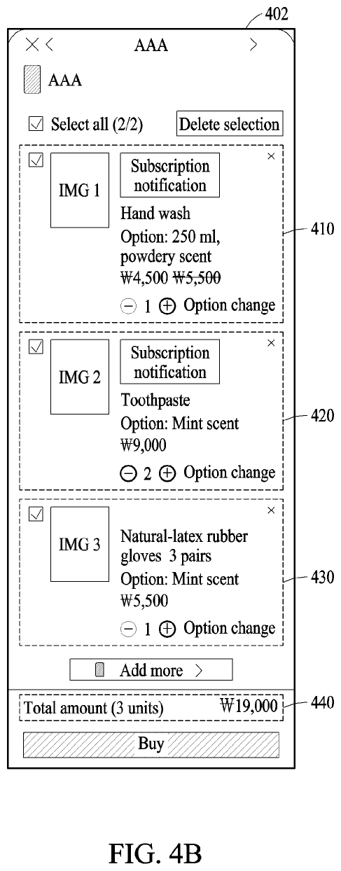

According to an example embodiment, order information of a new product (e.g., the second product) may be added, by a user's additional input, to the product order information included in the to-buy list, and the order information of the user's additional input may be received through the interface 302 related to the to-buy list. For example, the interface related to the to-buy list may further include an interfacing object 340 for requesting the addition of order information of the new product. Described in detail with reference to FIGS. 4A and 4B hereinafter is an example embodiment in which order information of a new product is added to the to-buy list based on an additional input of order information received through the interface related to the to-buy list.

In response to the input of selecting an interfacing object 350 for an order request as shown in FIG. 3B, an order book for purchase information of a product included in the to-buy list may be generated. As described above, an order may be requested for all the products included in the to-buy list, or an order may be requested for some selected product(s) included in the to-buy list. The input of selecting the product order information for generating an order book may be received through interfacing objects 326 and 336 (e.g., a check box) for selecting product order information included in the interface 302. A user may input the selection of the order information through interfacing objects 326 and 336 and input an order request to generate an order book corresponding to the selected order information.

FIG. 3C is a diagram illustrating an interface related to an order book according to an example embodiment.

Referring to FIG. 3C, an interface 303 regarding a generated order book may be provided to a second user's terminal. The interface 303 regarding the order book may include content to visually display information of the order request. For example, the interface 303 regarding the order book may include an item 360 for displaying delivery information, an item 370 for displaying product order information, and an item for displaying a payment amount. The item for displaying the payment amount may include an item 380 for displaying discount information according to an application for a subscription notification. The amount indicating the payment amount may further include information about a payment amount for the total products requested to be ordered and information about payment according to the order, such as a shipping cost.

The interface 303 related to the order book according to an example embodiment may include an interfacing object 390 for payment. For example, in response to the input of selecting the interfacing object 390, a payment request and payment operation may be processed. A successful payment for the order book may complete the processing of the order to book.

FIGS. 4A and 4B are diagrams illustrating an operation of adding product order information to a to-buy list according to an example embodiment.

As an example, in response to the input of selecting the interfacing object 340 for adding a product as shown in FIG. 3B, a store interface 401 for placing an additional order as shown in FIG. 4A may be provided to a terminal of a second user. The store interface 401 may include an interface that provides a sale product corresponding to a channel of a first user registered in the interlocking store platform. The second user may select a product to additionally buy through the store interface 401 and input product order information corresponding to the selected product so that the second user may request a server to add the additional product to order information of a product selected in a to-buy list.

Referring to FIG. 4B, in addition to items 410 and 420 about order information of a first product, which are generated based on the subscription notification data included by default in the to-buy list, an item 430 about order information of a second product added by the second user's input may be displayed on an interface 402 of the to-buy list. The order information of the added second product may be displayed separately from the order information of the first product generated based on the subscription notification data. For example, a “subscription notification” indication may be added to the items 410 and 420 of the order information of the first product generated based on the subscription notification data, but the subscription notification indication may not be added to the item 430 of the order information of the added second product.

According to an example embodiment, in response to each of the products included in the to-buy list, the server may determine whether an applicable product corresponds to a product corresponding to the subscription notification data. When it is determined that the applicable product corresponds to the first product corresponding to the subscription notification data, the server may identify a price to which a discount is applied according to the subscription notification service. For example, a product A may be determined to be the first product corresponding to the subscription notification data, and the item 410 of the product A order information may include a price to which a discount is applied according to the identified subscription notification service. The product determined to be the first product corresponding to the subscription notification data may include a product which is set not to apply a discount according to the subscription notification service. For example, a product B may be determined to be the first product corresponding to the subscription notification data, and the product B may correspond to a product set not to apply a discount according to the subscription notification service. In this case, a general price without a discount may be displayed in the item 420 of the product B order information.

According to an example embodiment, in response to each of the products included in the to-buy list, the server may determine whether an applicable product corresponds to the subscription notification data. When the applicable product is determined to be the second product which does not correspond to the subscription notification data, the server may identify a price which a discount is not applied according to the subscription notification service. For example, a product C may be determined to be the second product that does not correspond to the subscription notification data, and the item 430 of the product C order information may include a price to which a discount is not applied according to the identified subscription notification service.

According to an example embodiment, the total price determined based on the identified prices of the products included in the to-buy list may be provided to a terminal of the second user through the to-buy list. For example, the interface 402 regarding the to-buy list may include an item 440 for displaying the sum of the prices in the items 410, 420, and 430 of the product order information.

According to an example embodiment, the order information of the added second product may correspond to a product for which a subscription notification is not set. The to-buy list may be newly generated in response to a purchase request of an applicable subscription notification cycle in every subscription notification cycle that comes periodically from the subscription notification service and be automatically deleted when the applicable notification cycle ends. Therefore, the order information of the second product may not be included in the to-buy list generated based on a notification message in response to the next subscription notification cycle.

According to an example embodiment, a request for setting the subscription notification may be made for the order information of the second product based on the order book including the order information of the added second product. In this case, in response to the subscription notification data, the subscription-notification target data for the second product may be generated and saved in the database, and the order information of the second product may be included in the order information of the first product in the to-buy list generated based on the notification message corresponding to the next subscription notification cycle.

According to an example embodiment, when a request for setting the subscription notification is made for the order information of the added second product, the subscription notification data may be newly generated in response to an order book including the order information of the first product and the order information of the second product. In this case, in response to the newly generated subscription notification data, subscription-notification target data regarding the first product and the second product included in the order book may be newly generated and stored in the database.

FIGS. 5A and 5B are diagrams illustrating an operation of a request for setting a subscription notification according to an example embodiment.

According to an example embodiment, when a product for which a subscription notification may be set is included in an order book generated based on an order request for order information of at least one product but the second user does not set the subscription notification for the product, a request for setting the subscription notification for the order book may be made to the server through the interface related to the order book transmitted to the second user's terminal.

For example, referring to FIG. 5A, an interfacing object 520 for applying for the subscription notification may be provided before payment through the interface 501 related to the order book. The subscription notification corresponding to the order book may be applied for through the input of selecting the interfacing object 520 for applying for the subscription notification, included in the interface 501 regarding the order book. That is, the server may be requested to set the subscription notification for the order information of the product, which is available for the subscription notification and included in the order book, through the interfacing object 520. When the subscription notification corresponding to the order is applied for, the subscription notification data corresponding to the order book may be generated and stored in the database. For example, when the order book includes order information 511 of a product A and order information 512 of a product B, which are available for the subscription notification, subscription-notification target data for the order information of the two products included in the order book may be generated and stored in response to the generated subscription notification data.

According to an example embodiment, when the order book includes order information of a product for which the subscription notification may not be applied, the subscription notification may not be set for the order information of the product, and the subscription-notification target data corresponding to the order information of the product may not be set.

As another example, referring to FIG. 5B, an interfacing object 530 for applying for the subscription notification may be provided after payment through an interface 502 related to the order book. The subscription notification corresponding to the order book may be applied for by an input of selecting the interfacing object 530 for applying for the subscription notification, included in the interface 502 regarding the order book. When the subscription notification corresponding to the order book is applied for, the subscription notification data corresponding to the order book may be generated and stored in the database. For example, when the order book includes order information 511 of a product A and order information 512 of a product B, both of which may apply for the subscription notification, subscription-notification target data may be generated and stored for the order information of the two products included in the order book.

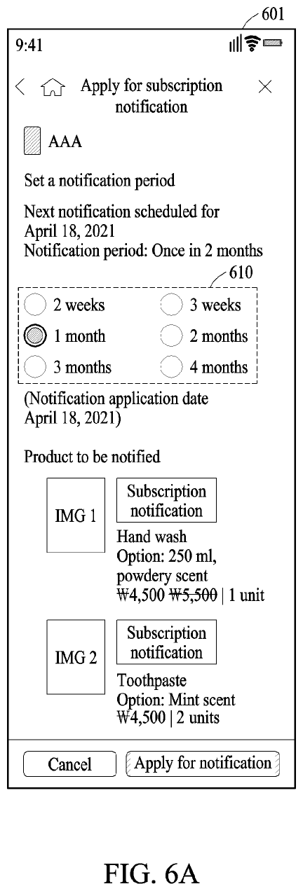

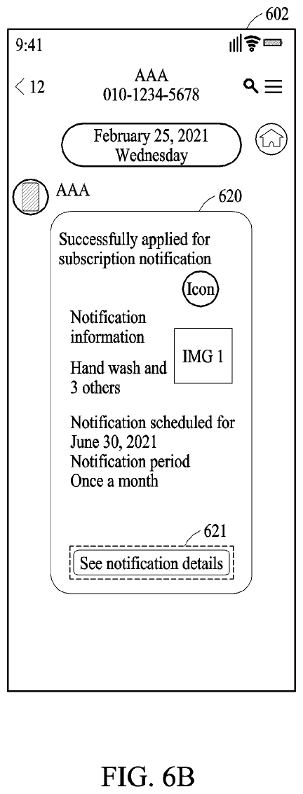

FIG. 6A is a diagram illustrating an interface screen for applying for a subscription notification according to an example embodiment.

According to an example embodiment, an interface for applying for the subscription notification may be provided to the second user's terminal in response to the subscription notification application for a second user's order book.

For example, referring to FIG. 6A, an interface 601 for applying for the subscription notification may be provided, to the second user's terminal, by the input of selecting the interfacing object 520 for applying for the subscription notification as shown in FIG. 5A or the interfacing object 530 for applying for the subscription as shown in FIG. 5B. According to an example embodiment, a notification cycle may be determined based on the interface 601 for applying for the subscription notification. For example, a time interval for the notification may be determined by the input of selecting any one of predetermined time intervals for the notification, or by a time interval of the notification input by the user.

According to an example embodiment, a subscription notification date, which is a scheduled date to send the subscription notification, may be determined based on the determined time interval of the notification and a date on which the subscription notification is registered. For example, the subscription notification date corresponding to a first notification may be determined to be a date obtained by adding a determined time interval of the notification to a registration date of the subscription notification. Also, for example, the subscription notification date to send an applicable subscription notification after the first subscription notification cycle may be determined to be a date obtained by adding a time interval of the notification to a subscription notification date of this subscription notification cycle.

According to an example embodiment, a cancellation date of the subscription notification may be determined through the interface 601 for applying for the subscription notification, and the subscription notification may be sent before the cancellation date of the subscription notification. For example, when the subscription notification date to send the subscription notification falls after the cancellation date of the subscription notification, the transmission of the subscription notification may be suspended.

FIG. 6B is a diagram illustrating a configuration of a message of a completed application for a subscription notification to be sent when a subscription notification for an order book is applied for, according to an example embodiment.

Referring to FIG. 6B, when an application for the subscription notification of the order book is completed, a subscription-notification application-completion message 620 may be transmitted to a second user's terminal through a chatroom 602 of a first user's channel. For example, the subscription-notification application-completion message 620 may be generated to include content (e.g., a text, an image, a video, and/or audio) indicating information of a product subject to the subscription notification and/or content indicating information of the subscription notification included in the subscription notification data.

According to an example embodiment, the subscription-notification application-completion message 620 may include an interfacing object 621 for requesting detailed information of the subscription notification that has been applied for. The interface related to the detailed information of the subscription notification that has been applied for may be provided through the interfacing object 621. The interface for the detailed information of the subscription notification may display information about a product for which the subscription notification is set, a subscription notification cycle, a registration date, a cancellation date, and a date to send the subscription notification, and may include an interfacing object for changing a setting of the subscription notification.

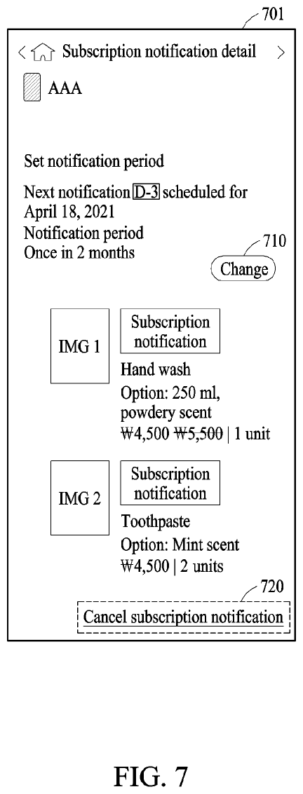

FIG. 7 is a diagram illustrating an interface screen related to detailed information of a subscription notification according to an example embodiment.

A setting of the subscription notification according to an example embodiment may be changed after being set. For example, a subscription-notification detail-interface 701 for displaying the detailed information of the subscription notification setting as illustrated in FIG. 7 may be provided to a second user's terminal by an input of selecting the interfacing object 315 included in the subscription notification message 310 transmitted through the chatroom of the seller's channel as illustrated in FIG. 3A. Also, for example, the subscription-notification detail-interface 701 for displaying the detailed information of the subscription notification setting as illustrated in FIG. 7 may be provided by an input of selecting the interfacing object 621 included in the message for notifying the subscription notification application to be transmitted through the chatroom of the seller's channel as illustrated in FIG. 6B. In addition, the subscription-notification detail-interface 701 for displaying the detailed information of the subscription notification setting may be provided to the second user's terminal through various entry points.

Referring to FIG. 7, the subscription-notification detail-interface 701 may include an interfacing object 710 for changing a determined subscription notification cycle and an interfacing object 720 for canceling the subscription notification. A user may transmit, to the server, a command for changing a subscription notification cycle through the input of selecting the interfacing object 710 for changing the subscription notification cycle and may send a command for canceling the set subscription notification through the input of selecting the interfacing object 720 for cancelling the subscription notification. A request for cancelling the subscription notification may be made in unit of an order book. When the request for cancelling the subscription notification corresponding to the order book is made, subscription notification data corresponding to the applicable order book may be deleted in the database and the subscription-notification target data corresponding to the deleted subscription notification data may also be deleted.

According to an example embodiment, a processor, a memory, and an input/output device may be included in the server which provides the subscription notification service in connection with the messaging server.

The processor of the server according to an example embodiment may perform an operation of at least one subscription notification services described above with reference to FIGS. 1 to 7. For example, the processor of the server may be configured to extract data on a subscription notification, of which a date is approaching, based on a database storing information about the subscription notification set in response to a concluded order book, requesting the messaging server to transmit a notification message corresponding to the subscription notification data based on seller's identification information and buyer's identification information included in the extracted subscription notification data, generating a to-buy list including order information of at least one first product corresponding to the subscription notification data in response to a purchase request through the notification message, and providing the generated to-buy list to a terminal of a second user who has transmitted the purchase request.

The memory of the server according to an example embodiment may store information related to the subscription notification service such as information required for providing the subscription notification service and information generated by providing the subscription notification service. The memory may include, for example, a volatile memory or a non-volatile memory.

According to an example embodiment, the server may be connected to an external device (e.g., a personal computer (PC) or a network) through an input/output device to exchange data with the external device. For example, the server may transmit and receive data with a terminal of a user through the input/output device.

According to an example embodiment, the memory of the server may store a program in which the above-described method of providing the subscription notification service is implemented. The processor of the server may execute the program stored in the memory of the server and control the server.

The example embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described example embodiments, or vice versa.

As described above, although the example embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of providing a subscription notification service performed by a server interworking with a messaging server, the method comprising:
extracting data on a subscription notification, of which a date is approaching, based on a database storing information about the subscription notification set in response to a concluded order book;
requesting the messaging server to transmit a notification message corresponding to the subscription notification data based on seller's identification information and buyer's identification information comprised in the extracted subscription notification data;
generating a to-buy list comprising order information of at least one first product corresponding to the subscription notification data in response to a purchase request through the notification message; and
providing the generated to-buy list to a terminal of a user transmitting the purchase request.

2. The method of claim 1, wherein the to-buy list corresponds to a digital shopping cart dedicated to the subscription notification service which is newly generated in response to a purchase request of an applicable notification cycle in each notification cycle that comes periodically from the subscription notification service and automatically deleted when the applicable notification cycle ends.

3. The method of claim 1, further comprising, in response to each of products comprised in the to-buy list:
determining whether an applicable product corresponds to a product in the subscription notification data;
identifying a price to which a discount by the subscription notification service is applied when the applicable product corresponds to the product in the subscription notification data; and
identifying a price to which a discount by the subscription notification service is not applied when the applicable product does not correspond to the product in the subscription notification data,
wherein a total price determined based on the identified prices of the products is provided through the to-buy list.

4. The method of claim 1, wherein the to-buy list is modified to comprise at least one second product other than the at least one first product in response to a current notification cycle.

5. The method of claim 1, wherein the generating of the to-buy list comprises:
retrieving data on at least one subscription-notification target corresponding to the subscription notification data in the database, in response to the purchase request though the notification message; and
generating the to-buy list comprising order information of the first product based on the retrieved subscription-notification target data.

6. The method of claim 1, wherein the extracting of the subscription notification data further comprises updating a subscription notification date corresponding to the subscription notification data stored in the database, based on a time interval of the subscription notification comprised in the subscription notification data.

7. The method of claim 1, wherein the information about the subscription notification comprises:
the subscription notification data generated in response to the order book for which the subscription notification is set; and
subscription-notification target data generated based on order information of at least one product comprised in the order book.

8. The method of claim 1, wherein the notification message is transmitted to a terminal logged into an account of a second user corresponding to the buyer's identification information through a channel of a first user corresponding to the seller's identification information.

9. The method of claim 1, wherein the providing of the to-buy list further comprises receiving an order request corresponding to the to-buy list from the terminal of the user.

10. A non-transitory computer-readable medium storing instructions that, when executed by a processor, cause the processor to perform the method of claim 1.

11. A server interworking with a messaging server to provide a subscription notification service, the server comprising at least one processor configured to:
extract data on a subscription notification, of which a date is approaching, based on a database storing information about the subscription notification set in response to a concluded order book;
request the messaging server to transmit a notification message corresponding to the subscription notification data based on seller's identification information and buyer's identification information comprised in the extracted subscription notification data;
generate a to-buy list comprising order information of at least one first product corresponding to the subscription notification data in response to a purchase request through the notification message; and
provide the generated to-buy list to a terminal of a user transmitting the purchase request.

12. The server of claim 11, wherein the to-buy list corresponds to a digital shopping cart dedicated to the subscription notification service which is newly generated in response to a purchase request of an applicable notification cycle in each notification cycle that comes periodically from the subscription notification service and automatically deleted when the applicable notification cycle ends.

13. The server of claim 11, wherein the processor is configured to, in response to each of products comprised in the to-buy list:
determine whether an applicable product corresponds to a product in the subscription notification data;
identify a price to which a discount by the subscription notification service is applied when the applicable product corresponds to the product in the subscription notification data; and
identify a price to which a discount by the subscription notification service is not applied when the applicable product does not correspond to the product in the subscription notification data,
wherein a total price determined based on the identified prices of the products is provided through the to-buy list.

14. The server of claim 11, wherein the to-buy list is modified to comprise at least one second product other than the at least one first product in response to a current notification cycle.

15. The server of claim 11, wherein the processor is configured to, in the generating of the to-buy list:
retrieve data on at least one subscription-notification target corresponding to the subscription notification data in the database, in response to the purchase request though the notification message; and
generate the to-buy list comprising order information of the first product based on the retrieved subscription-notification target data.

16. The server of claim 11, wherein the processor is configured to, in the extracting of the subscription notification data, update a subscription notification date corresponding to the subscription notification data stored in the database, based on a time interval of the subscription notification comprised in the subscription notification data.

17. The server of claim 11, wherein the information about the subscription notification comprises:
the subscription notification data generated in response to the order book for which the subscription notification is set; and
subscription-notification target data generated based on order information of at least one product comprised in the order book.

18. The server of claim 11, wherein the notification message is transmitted to a terminal logged into an account of a second user corresponding to the buyer's identification information through a channel of a first user corresponding to the seller's identification information.

19. The server of claim 11, wherein the processor is configured to, in the providing of the to-buy list, receive an order request corresponding to the to-buy list from the terminal of the user.
